(19) United States
(12) Patent Application Publication
(10) Pub. No.: US 2025/0154627 A1
(43) Pub. Date: May 15, 2025

(54) PROCESS FOR THE RECOVERY OF LI, NI AND CO

(71) Applicant: Umicore, Brussels (BE)

(72) Inventors: Pieter VERHEES, Olen (BE); Michael BALTES, Olen (BE)

(21) Appl. No.: 18/838,403

(22) PCT Filed: Feb. 15, 2023
(86) PCT No.: PCT/EP2023/053742

§ 371 Date: Aug. 14, 2024

(30) Foreign Application Priority Data
Feb. 16, 2022 (EP) 22157033.6

(51) Int. Cl. C22B 26/12; C01G 51/15; C01G 53/11; C22B 3/44; C22B 47/00; H01M 10/54

(52) U.S. Cl. CPC C22B 26/12; C01G 51/15; C01G 53/11; C22B 3/44; C22B 47/00; H01M 10/54

(57) ABSTRACT

Process for the separation of Li from oxides of one or more of Co and Ni contained in a feed, comprising the steps of: contacting, in aqueous medium, the feed with a quantity of sulfidizing agent, sufficient to convert a major part of the Co and/or Ni to sulfides, and a quantity of mineral acid sufficient to reach a pH of 1 to 5, thereby forming an aqueous slurry containing solid Co and/or Ni sulfides, and a solution containing Li; and, separating the solids from the solution, thereby obtaining solids containing Co and/or Ni sulfides, and a solution containing at least 70% of the Li. This process allows to convert Co and Ni to solid sulfides and at the same time to efficiently separate them from soluble compounds such as Li, Mn and other impurities.

### CROSS REFERENCE TO RELATED APPLICATIONS

This application is a U.S. National Stage Application of International Patent Application No. PCT/EP2023/053742, filed on Feb. 15, 2023, which claims priority to European Patent Application No. 22157033.6, filed on Feb. 16, 2022.

The present invention is related to a process for the recovery of Li, Ni and/or Co from solid starting materials such as those comprising rechargeable lithium-ion batteries or their scrap.

Currently prevailing rechargeable battery chemistries involve cathode powders containing the metals lithium, nickel, manganese, and cobalt (NMC). Other frequently used chemistries make use of cathode powders containing lithium, nickel, cobalt, and aluminum (NCA), or containing lithium, nickel, cobalt, manganese, and aluminum (NMCA). Future possible chemistries may replace lithium by sodium. When recycling any of those, the separation of Ni or Co from alkali metals such as Li and Na is a challenge.

There is an increasing need for the recycling of lithium-ion batteries, comprising both production waste and end-of-life batteries. This results in complex waste streams, in which all types of lithium batteries and their components, such as electrode foils, electrolytes, separators, casing material, electrical or electronic components, are possibly further mixed with non-lithium batteries, such as nickel-cadmium, nickel-metal-hydride, and zinc-based batteries. Derivatives of these production wastes and end-of-life batteries are also available for recycling, in the form of powder fractions or black masses, which are the result of a mechanical and/or thermal pretreatment.

The chemical complexity of scrapped materials increases towards the end of the manufacturing process, as more and more ingredients are added to the product. Hence, battery cells and modules may contain a huge number of different elements, for example: Ni, Co, Mn, Li, Na, Fe, Al, V, P, F, C, Ti, and Mg in the cathode; Li, Ti, Si, C, Al, and Cu in the anode; Li, F, P, and volatile organic compounds in the electrolyte; and Al, Fe, Cu, Ni, Cr, together with plastics with Cl, Br and Sb in the casing.

The amount of spent batteries is expected to exceed 100,000 t per year during the coming 10 years, mainly due to the ongoing electrification of the automotive industry. The battery recycling business will grow correspondingly.

US2019152797 gives an example of a traditional battery scrap recycling process, in which solvent extraction is used to extract Co and Ni from a purified leach solution. This operation consumes base, such as NaOH or NH₄OH, stoichiometrically with the amount of recovered Ni and Co. The consumption of base is a significant operational cost, resulting also in a large salt discharge, which can be problematic for the environment. Furthermore, recovery of lithium from the effluent is not straightforward due to the low Li-concentration. Extraction steps are expensive because they usually require using specific and costly extraction agents and are performed in multiple process steps.

Some battery recycling processes use sulfidizing agents to separate Ni and Co from elements such as Al, Li, F, or Na. In CN102492858, a battery recycling process using sulfides is proposed, comprising the steps: (1) leaching of the battery scrap, (2) removal of Al and Fe by hydrolysis, and (3) precipitation of Ni and Co sulfide from the solution using a sulfidizing agent. Ammonium sulfide (NH₄)₂S is preferred as sulfidizing agent since it does not affect the pH of the solution. While avoiding the use of solvent extraction and its disadvantages, this recycling approach has similar disadvantages as the traditional approach: (1) it consumes base stoichiometrically with the amount of Ni and Co that is precipitated, and (2) the recovery of lithium from the effluent is not straightforward.

Some battery recycling processes are proposed that do not consume base and directly convert Ni or Co oxides to sulfides. In CN111994966, battery scrap is roasted with hydrogen sulfide at a high temperature of 600 to 1000° C. US2021277531 describes sulfidation of Ni and Co in battery scrap at 1000° C. with gaseous sulfur. This process allows separating Ni and Co from Al, Li, and Mn by flotation. However, the use of gaseous sulfur or hydrogen sulfide at high temperatures makes the processes industrially challenging due to corrosion, to complex flue gas treatment, and to general safety issues.

It is therefore an object of the present invention to provide a low temperature selective process for the separation of Li from a solid containing Ni and/or Co, using sulfidizing agents, while mitigating base consumption.

The current invention advantageously uses the difference in solubility of certain metal sulfides. Monhemius (Monhemius J.; 1977; Precipitation diagrams for metal hydroxides, sulfides, arsenates and phosphates) reports the theoretical solubility of metal sulfides as Cu²⁺<Co²⁺<Ni²⁺<Mn²⁺<Li⁺. Sulfide precipitation of metals is often employed in wastewater treatment.

Popular sulfidizing agents are Na₂S, NaHS, and H₂S. In the current invention, the sulfidizing agents not only act as precipitation agent to form metal sulfides, but advantageously also as reducing agent for higher valent metals in oxidation states such as Me³⁺ or Me⁴⁺. This is further detailed below.

Known processes typically perform sulfide precipitation with H₂S starting from a Ni-bearing solution. Such a solution may already be acidic, in particular when it originates from a leaching operation. The sulfide precipitation generates even more acid according to the reaction: NiSO₄+H₂S→NiS+H₂SO₄.

Precipitation of Ni with H₂S thus results in an equimolar amount of additional acid. This acid needs to be neutralized: if it is not neutralized, the equilibrium of the precipitation reaction will shift to the left, and the precipitation reaction will be slowed down, not run to completion, or even stop completely.

Neutralization implies the addition of a base, which unavoidably results in a salt-enriched solution. Such a process is described in EP2669390 A1. This document teaches a process for the recovery of valuable metals from battery cathodes, comprising a step of leaching the feed in acidic conditions, followed by a step sulfidizing the leachate using H₂S, thereby precipitating valuable metals like Ni as sulfides. This 2-step process bears the above-mentioned disadvantage of the generation of acid during sulfide precipitation.

Contrary to the above, the present process starts from solid Ni oxides, converting them directly to sulfides in a wet process according to: NiO+H₂S→NiS+H₂O.

No additional acid is formed. There is thus no need for a neutralizing base, and the production of additional salts is completely avoided.

Metals occur in battery scrap mostly as oxides. Ni and Co are present as Me²⁺ and/or as higher valent cations such as Me³⁺. In this latter case, reduction to the bivalent state occurs together with the conversion to sulfides. A representative example is the conversion of Co sesquioxide to CoS according to:

Co₂O₃+3H₂S→2 CoS+3H₂O+S.

In this reaction, Co oxide is reduced and converted to Co sulfide, while H₂S is oxidized to elemental S. The conversion of Ni and Co oxides to sulfides will liberate any lithium oxide or manganese oxide from the matrix. When converting a typical mixed oxide corresponding to a so-called 3:1:1 Ni: Co: Mn battery chemistry, additional acid is needed to dissolve Li and Mn. This is illustrated by the equation:

10 LiNi_{0.6}Co_{0.2}Mn_{0.2}O₂+13 H₂S+7 H₂SO₄→5 Li₂SO₄+2 MnSO₄+2 CoS+6 NiS+5 S+20 H₂O.

Contrary to known processes where a neutralizing base is needed, the present process allows to control the pH by addition of acid. No supplemental salts are produced. Preferably, the acid is a mineral acid, such as H₂SO₄.

A solution containing Li and other soluble metals is obtained by the described process. Several options are available to recover Li from this solution. For example, Li may be precipitated as an insoluble Li salt such as Li₂CO₃. It is preferred to first remove other metals such as Al or Mn from the Li solution to precipitate pure Li salt. Other processes such as solvent extraction or crystallization processes can also be adopted to treat the Li-bearing solution.

A first embodiment describes a process for the separation of Li from oxides of one or more of Co and Ni contained in a feed, comprising the steps of:
contacting, in aqueous medium, the feed with a quantity of sulfidizing agent, sufficient to convert a major part of the Co and/or Ni to sulfides, and a quantity of mineral acid sufficient to reach a pH of 1 to 3, at an absolute pressure of less than 0.3 MPa, thereby forming an aqueous slurry containing solid Co and/or Ni sulfides, and a solution containing a major part of the Li;
separating the solids from the solution, thereby obtaining solids containing Co and/or Ni, and a solution containing at least 70% of the Li.

Besides the Li and the oxides of Co and/or Ni, a typical battery scrap-based feed may also contain anode materials such as carbon, electrode foils, and electrolytes.

Preferably, at least a major part of Co and/or Ni contained in the feed is in the form of their respective metallic oxides, more preferably at least 80%, most preferably at least 90%, by weight. The remainder may comprise Co and/or Ni in metallic form.

By the “major part” of an element or compound is meant at least 50% by weight of that element or compound, relative to its total process input.

The mineral acid is preferably chosen from the list consisting of H₂SO₄, HCl, H₃PO₄, and HNO₃, or mixtures thereof. H₂SO₄ and HCl are more preferred.

The contacting step is advantageously performed in a reactor, preferably of the closed type to avoid the emanation of hazardous gases.

By aqueous medium is meant a water-based solution. The aqueous medium facilitates the handling of the contents of the reactor, such as mixing or pumping. The aqueous medium may already contain some of the other ingredients taking part in the reaction, or those can be added later. It may in particular contain the mineral acid.

The sulfidizing agent used in the contacting step should obviously be susceptible to react with Co and/or Ni oxides. Suitable sulfidizing agents should therefore preferably be at least partially soluble in the aqueous medium. Otherwise they cannot efficiently serve as source of sulfides for the described process.

The mentioned pH range corresponds to the pH of the solution measured at 40° C. after purging any dissolved H₂S. Working at the upper end of the claimed pH-range, for example between 3.5 and 5, reduces the overall yield of the conversion of Co and/or Ni to sulfides. Therefore, contacting with a quantity of mineral acid sufficient to reach a pH of 1.5 to 3.3 is preferred; a pH of 2 to 3 is more preferred.

In battery scrap, Li is most likely present as Li₂O, LiF, LiPF₆, Li₂CO₃, or LiOH. Acid needs to be added stoichiometrically in order to dissolve all of the contained Li compounds.

Working in the given pH-range allows to maximize the dissolution of lithium, while at the same time promoting the formation of Ni and/or Co sulfides. This way, soluble compounds, such as Li, are efficiently separated from solid Ni and/or Co sulfides. If an excess of acid is added, Ni and Co oxides may partially dissolve. Therefore, addition and consumption of acid during the process should be well controlled by monitoring the pH, reaching a pH within the above-defined limits. This means that such a pH is to be reached at the end of a batch process, or that it should be maintained when the process is run as a continuous process.

In a further embodiment, the sulfidizing agents used in the contacting step is one or more of H₂S, NaHS and Li₂S. H₂S and NaHS are the preferred sources of sulfides. H₂S is more preferred. It can be brought in as such, but also generated from H₂, S or metal sulfides in an industrial setup. Using a suitably equipped reactor, H₂S can be introduced by injection into the slurry, or by working under H₂S atmosphere. Preferably, this H₂S atmosphere is created in the headspace of the reactor. For safety reasons, working below atmospheric pressure is an advantage. On the other hand, working with a higher pressure of H₂S accelerates the reaction kinetics. The amount of added sulfidizing agent is preferably sufficient to saturate the slurry in H₂S. The saturation is easily verified by monitoring the absorption rate of H₂S by the reacting mixture. Saturation provides for optimal kinetics.

It is assumed that NaHS forms H₂S, which dissolves and reacts with the slurry, and NaOH, which reacts with acid to form salt. This salt, although generated in limited quantities, is less desired. Na₂S can also be used as sulfidizing agent. However, it generates twice as much salt as NaHS, and is therefore even less desired. Ammonium sulfide can also be used.

Suitable sulfidizing agents should preferably be at least partially soluble in the aqueous medium. For example, Li₂S reacts with the slurry to form a soluble Li salt and a soluble sulfide. On the other hand, sulfides which are insoluble under the described conditions, for example CuS, are not considered a suitable source of sulfides, respectively a sulfidizing agent according to the invention.

In a further embodiment, the sulfidizing agent used in the step of contacting is generated in situ, by adding elemental sulfur under reducing conditions. Elemental S may for example be reduced using H₂ in the reactor, thereby forming H₂S.

In a further embodiment, the quantity of mineral acid in the step of contacting is at least partially generated in situ by addition of a solution containing dissolved Co and/or Ni.

Usually, the mineral acid is added as such. But acid can also be produced by adding a solution comprising for example NiSO₄ or NiCl₂. Upon contact with a sulfidizing agent, these metals precipitate and produce acid in situ. A further advantage of this embodiment is the increase of the total amount of Co and/or Ni in the process. The process is sufficiently robust to cope with Co and/or Ni containing solutions from impure waste streams.

In a further embodiment, the step of contacting is performed in a continuous operation. In such a setup, the feed and acid are added continuously to the reactor while the slurry is extracted from the reactor. The addition and extraction can also be performed batchwise, e.g. repeatedly, every 30 minutes. Continuous operation has several advantages. Firstly, continuous operation intensifies the use of reactor equipment. Secondly, the quality of the solid Co and/or Ni sulfides is more consistent since they are formed in a steady state regime. This facilitates further refining.

In a further embodiment, the solids obtained in the step of separating, comprise at least 70% of the Co and/or Ni, preferably at least 85% of the Co and/or Ni and more preferably at least 90% of the Co and/or Ni.

The process allows for high recovery rates of valuable metals such as Co and/or Ni, which is important in an industrial setup.

In a further embodiment, the solution obtained in the step of separating, comprises at least 85% of the Li and more preferably at least 90% of the Li.

The separation of Li and of other impurities from the solid Co and/or Ni sulfides facilitates the further refining of these sulfides.

Mn is in present in most cathode active material and thus also ends up in the battery scrap. Therefore, in a further embodiment, the feed further contains oxides of Mn. Mn is dissolved together with the lithium, thereby obtaining a solution containing the major part of the lithium and the major part of the manganese.

In a further embodiment, said solution comprises at least 70% of the Mn, preferably at least 85% of the Mn, and more preferably at least 90% of the Mn.

According to the process, Mn dissolves. No Mn sulfides are formed and Mn does therefore not report to the residue. This is an additional remarkable benefit of the process since it facilitates the refining of the solid residue comprising the Co and/or Ni sulfides.

Besides Li and Mn, the process advantageously also dissolves numerous further impurities that may be present in battery scrap, such as Al, F, W, Si, Ca, Mg, P, C, K, Fe, Cl, SO₄, and Na. Other impurities such as Cu, Zn, Pb, and Cd will report to the solid residue.

The dissolution of Mn and of other soluble impurities also consumes a stoichiometric amount of acid.

In a further embodiment, at least the metal oxides contained in the feed are in the form of a powder, having preferably an average particle size D50 (volumetric median) of less than 100 μm, more preferably of less than 50 μm and most preferably of less than 30 μm.

The particle size distribution is measured according to ASTM B822-97 Standard.

The metal oxides are better accessible for reactions when present in form of a powder. An average particle size of less than 100 μm, less than 50 μm, or even less than 30 μm is therefore preferred in an industrial setup. It is not required that such a powder is a dry powder, it could as well originate from a wet process, for example a filter cake. This is particularly advantageous as it has been found that the formation of Ni and Co sulfide is the rate-determining step.

In a further embodiment, the mixed oxides are derived from Li-ion batteries, battery scrap and/or their production waste. Economically most interesting in this regard are all parts and materials coming from the cathode materials used in these Li-ion batteries.

In a further embodiment, the process is performed at a temperature of 80° C. or less, preferably 65° C. or less, and more preferably 50° C. or less. The process can be performed across a wide temperature range, from 15° C. up to the boiling point of the aqueous solution. It is observed that even at moderate temperatures, such as 65° C. or less, the reaction rate is sufficient. A lower temperature increases H₂S absorption in the reacting mixture and limits corrosion. Hence, temperatures of 65° C. or less are preferred.

The reaction is slightly exothermic, spontaneously heating the aqueous slurry to a temperature of 40-50° C. So, advantageously, no external heating is required. While the process would work also at temperatures below 40° C., this is not practical, as active cooling would be required. Working in the range of 40-50° C., without additional heating or cooling is therefore most preferred.

In a further embodiment, the amount of mineral acid is predetermined according to stoichiometric reactions, the addition being performed in at least 2 steps, the first addition step being limited to at most 80%, preferably at most 90% of the predetermined amount.

The proposed controlling approach minimizes the need for online measurement equipment and, therefore, mitigates the impact of measurement deviations, and increases robustness of the process. Furthermore, by adopting this approach, the kinetics of the process will depend on the sulfide formation and not on the availability of H₂SO₄ or other mineral acids. Adopting this approach and staying under-stoichiometric in the first addition step with regards to the mineral acid added, generally saves time.

In a further embodiment, the first addition step is terminated at a pH above 3.3. The second or any subsequent addition step is terminated at a pH between 1.5 and 3.

A multi-step process is advantageous where most of the process is performed at moderate to high pH, such as a above 3.3, while in the second or any subsequent addition step the pH is lowered to between 1.5 and 3. Sulfide formation kinetics are higher at higher pH. For that reason, it is advantageous to perform most of the process at relatively high pH since sulfide formation is the rate limiting step. The lower pH in the second or any subsequent addition step is selected to maximize the dissolution of Li, Mn, and other impurities. After every such addition step, optionally, a solid-liquid separation can be performed. Most of the conversion to sulfides is usually performed in the first reaction step and then completed with the second or any subsequent addition step. Since sulfide formation will not occur at a pH below 1, the process must be completed at a pH between 1 and 5. Working at a pH above the upper limit would result in an insufficient dissolution of Li and Mn.

After completion of the process, the pH may be further lowered to below 1.5 in order to maximize impurity removal. Indeed, while the formed metal sulfides will not redissolve in absence of an oxidizing agent, some impurities can be eliminated from the residue.

The solid residue containing the major part of the Co and/or Ni as Co and/or Ni sulfides, obtained in the step of separating the solids from the solution, can be further treated in different ways. Hydrometallurgical treatment of the solid residue is a preferred option.

A further embodiment describes therefore a process, in which the solid residue is used as starting material in a subsequent hydrometallurgical refining process. The hydrometallurgical refining process comprises the steps of:
leaching the solid residue comprising the Co and/or Ni sulfides with a mineral acid, preferably H₂SO₄, thereby obtaining a Ni- and/or Co-bearing solution;
under the provision that insoluble solids remain, separating the solution from said solids; and,
crystallizing Ni and/or Co from the Ni- and/or Co-bearing solution, preferably as Ni and/or Co sulfate.

The production of the solid residue comprising the Co and/or Ni sulfides depleted in Mn has several advantages for the hydrometallurgical refining process. It allows for more intensive processes as Mn does not dilute the Ni- and/or Co-bearing solution and the need to isolate Mn, e.g. by solvent extraction is avoided.

The leaching of sulfides can be performed at very high acidity to promote the formation of H₂S and enable recycling the H₂S formed during leaching to the conversion process. This limits the consumption of H₂S in the conversion process and limits the consumption of oxidizing agent in the leaching process.

The solid residue comprising the Co and/or Ni sulfides can also contain some C, originating from the anode, and metallic impurities such as Al and Cu, originating from the collector sheets. Prior to the leaching of the sulfides, a solid-solid separation can therefore be performed to separate the Co and/or Ni sulfides from C and/or metallic impurities. Flotation would be a suitable process.

The process to obtain the Co and/or Ni sulfides efficiently removes Li, but also other impurities. Consequently, any subsequent hydrometallurgical refining process will benefit from the higher purity, resulting for example also in a higher quality when crystallizing Ni- and/or Co.

A subsequent pyrometallurgical treatment of the solid residue comprising the Co and/or Ni sulfides is another option. A process similar to matte smelting is suitable. Matte smelting converts the solid residue into a sulfidic alloy and an oxidic slag. Such a high temperature treatment of the solid residue uses temperatures above 1000° C., preferably above 1200° C., or even above 1400° C. for harder to smelt compounds, whereby the temperature is chosen to ensure a liquid alloy and slag. Above-mentioned C and Al in the solid residue will contribute to heat generation for such a process.

A further embodiment describes therefore a process, in which the solid residue is used as starting material in a subsequent pyrometallurgical refining process.

Many traditional Ni—Co refineries are designed to treat sulfidic materials such as Ni or Cu matte. Hence, these refineries are equipped to further process the Co and/or Ni sulfides in the solid residue into pure Ni and/or Co products.

Optionally, an additional leaching step is performed on the residue containing Co and/or Ni sulfides. Use can be made of an aqueous mineral acidic solution at a pH between 0.5 and 2 to further dissolve any Li remaining in the residue. As it may also dissolve small amounts of Co and/or Ni, the solution from this leaching step could advantageously be recirculated to the contacting step, serving in that step as a source for part of the mentioned aqueous medium and mineral acid.

The invention is further illustrated in the following examples.

### EXAMPLE 1: USE OF H₂S AT 60° C. ON PYROLYZED BLACK MASS

250 g of black mass is added in a beaker. 0.8 L of water is added and the mixture is agitated. The black mass originates from end-of-life batteries and has been pyrolyzed at 550° C. for 3 h under N₂-atmosphere in order to liberate the cathode powder from the alumina foil. Black mass is obtained after comminution and sieving. The black mass comprises 12% Ni, 7.2% Mn, 3.3% Co, 3.1% Li, 3.8% Al, 1.5% Cu and 1.8% F. The rest of the mass mainly comprises C, P, and O.

H₂S is injected in the slurry at a constant rate of 10 g/h. The temperature is adjusted to 60° C. H₂SO₄ solution (1000 g/L) is added at a constant rate of 15 g/h. During the experiment, the temperature is maintained at 60° C., pressure in the reactor is maintained at 0.95 bar and H₂S is continuously injected at the specified rate. A sample of the slurry is taken each hour. The samples are cooled to 40° C. and purged with N₂ for 30 minutes before measuring the pH. The addition of H₂SO₄ is stopped when the pH of the slurry reaches 2.1, after about 15 h.

The slurry is filtered on a Buchner filter, resulting in a solution and solid residue. 156 g dry solid residue and 0.9 L solution is obtained.

The mass balance of the complete experiment can be found in Table 1 below.

TABLE 1
Metal input and yields (in g) in solid residue and solution at pH 2.1

| | Input | Solid residue | Solution |
|---|---|---|---|
| Ni | 30 | 27.8 | 2.2 |
| Mn | 18 | 0.9 | 17.1 |
| Co | 8.2 | 7.6 | 0.6 |
| Li | 7.7 | 0.3 | 7.4 |
| Al | 9.5 | 2.4 | 7.1 |
| Cu | 4.5 | 4.5 | 0.0 |
| Fe | 13.8 | 0.5 | 13.3 |

This experiment shows that under the current process conditions, 95% or more of the Li and Mn dissolve, while 90% or more of Ni and Co is in the solid residue and the dissolution of Ni and Co is minimized.

### EXAMPLE 2: USE OF H₂S AT 40° C. ON PYROLYZED BLACK MASS

300 g of black mass is added in a beaker. 0.8 L of water is added and the mixture is agitated. The black mass originates from end-of-life batteries and has been pyrolyzed at 550° C. for 3 h under N₂-atmosphere in order to liberate the cathode powder from the alumina foil. Black mass is obtained after comminution and sieving. The black mass comprises 20% Ni, 12.4% Mn, 10.5% Co, 4.55% Li, 5.2% Al, 6.1% Cu and 2.6% F. The rest of the mass mainly comprises C, P and O.

H₂S is injected in the slurry at a constant rate of 10 g/h. The temperature is adjusted to 40° C. H₂SO₄ solution (1000 g/L) is added with a constant rate of 24 g/h over a period of 15 h. During this period, the temperature is maintained at 40° C. and H₂S is continuously injected at the specified rate. After this period, the pH of slurry is 2.8.

The slurry is filtered on a Buchner filter, resulting in a solution and a solid residue. 194 g dry solid residue and 0.95 L solution is obtained. The mass balance of the complete experiment can be found in Table 2 below.

TABLE 2
Metal input and yields (in g) in solid residue and solution

| | Input | Solid residue | Solution |
|---|---|---|---|
| Ni | 60.0 | 58.6 | 1.4 |
| Mn | 37.2 | 1.1 | 36.1 |
| Co | 31.5 | 29.2 | 2.3 |
| Li | 13.7 | 0.6 | 13.1 |
| Al | 15.6 | 5.1 | 10.5 |
| Cu | 18.3 | 18.3 | 0 |

This experiment demonstrates that the yields obtained at 40° C. are similar to those obtained in Example 1 at 60° C.

### EXAMPLE 3: USE OF NAHS AND H₂SO₄ AT 80° C. ON MECHANICAL BLACK MASS

300 g of black mass is added in a beaker. 0.8 L of water is added and the mixture is agitated. The mechanical black mass is battery production scrap that is obtained after comminution (“wet crushing”) and sieving. The black mass comprises 18% Ni, 6.5% Mn, 6.5% Co, 3.8% Li, 1.5% Al, 0.4% Cu and 0.8% F. The rest of the mass mainly comprises C and O.

NaHS solution (300 g/L) is injected in the slurry at a constant rate of 115 g/h. The temperature is adjusted to 80° C. H₂SO₄ solution (1000 g/L) is added with a constant rate of 45 g/h over a period of 7 h. During this period, the temperature is maintained at 80° C. and NaHS is continuously injected at the specified rate. After this period, the pH of slurry is 3.

The slurry is filtered on a Buchner filter, resulting in a solution and solid residue. 302 g dry solid residue and 1.4 L solution is obtained. The mass balance of the complete experiment can be found in Table 3 below.

TABLE 3
Metal input and yields (in g) in solid residue and solution

| | Input | Solid residue | Solution |
|---|---|---|---|
| Ni | 54 | 53.9 | 0.1 |
| Mn | 19.5 | 0.7 | 18.8 |
| Co | 19.5 | 19.4 | 0.1 |
| Li | 11.4 | 0.2 | 11.2 |
| Al | 4.5 | 4.0 | 0.5 |
| Cu | 1.1 | 1.1 | 0.0 |
| F | 2.4 | 2.3 | 0.1 |

This experiment demonstrates that NaHS can be used as sulfidizing agent instead of H₂S.

### EXAMPLE 4: USE OF H₂S AND HCL AT 60° C. ON MECHANICAL BLACK MASS

250 g of black mass is added in a beaker. 0.8 L of water is added and the mixture is agitated. The black mass is battery production scrap and is obtained after comminution and sieving. The black mass comprises 18% Ni, 6.5% Mn, 6.5% Co, 3.8% Li, 1.5% Al, 0.4% Cu and 0.8% F. The rest of the mass mainly comprises C and O.

H₂S is injected in the slurry at a constant rate of 15 g/h. The temperature is adjusted to 60° C. HCl solution (430 g/L) is added with a constant rate of 14.3 g/h over a period of 15 h. During this period, the temperature is maintained at 60° C. and H₂S is continuously injected at the specified rate. After this period, the pH of slurry is 2.2.

The slurry is filtered on a Buchner filter, resulting in a solution and solid residue. 227 g dry solid residue and 0.95 L solution is obtained. The mass balance of the complete experiment can be found in Table 4 below.

TABLE 4
Metal input and yields (in g) in solid residue and solution

| | Input | Solid residue | Solution |
|---|---|---|---|
| Ni | 45 | 39 | 6 |
| Mn | 16 | 1 | 15 |
| Co | 16 | 14 | 2 |
| Li | 10 | 1 | 9 |
| Al | 3.8 | 3.4 | 0.4 |
| Cu | 0.9 | 0.9 | 0.0 |

This experiment demonstrates that HCl can be used as mineral acid instead of H₂SO₄.

### EXAMPLE 5: USE OF H₂S AND H₂SO₄ AT 60° C. ON MECHANICAL BLACK MASS

116 g H₂SO₄ solution (1000 g/L) and 0.95 L water is added to the reactor. H₂S is injected in the solution at a constant rate of 15 g/h. The temperature is adjusted to 60° C. Black mass is added to the reactor with a constant mass flow of 12.5 g/h for 12 h. The black mass is end-of-life battery scrap and is obtained after comminution and sieving. The black mass comprises 23% Ni, 6.4% Mn, 6.5% Co, 4% Li, 1.8% Al, 2.1% Cu and 1.1% F. The rest of the mass mainly comprises C, P and O.

During the 12 h in which the black mass is added, the temperature is maintained at 60° C. and H₂S is continuously injected. After adding the last quantity of black mass, H₂S is added for another 2 h at the specified rate. After this period, the pH of slurry is 2.2.

The slurry is filtered on a Buchner filter, resulting in a solution and solid residue. 167 g dry solid residue and 1.2 L solution is obtained. The mass balance of the complete experiment can be found in Table 5 below.

TABLE 5
Metal input and yields (in g) in solid residue and solution

| | Input | Solid residue | Solution |
|---|---|---|---|
| N | 34.5 | 31 | 3.5 |
| Mn | 9.6 | 0.2 | 9.4 |
| Co | 9.8 | 9 | 0.8 |
| Li | 6.0 | 0.4 | 5.6 |
| Al | 2.7 | 2.2 | 0.5 |
| Cu | 3.2 | 3.2 | 0.0 |
| F | 1.7 | 1.0 | 0.7 |

This experiment demonstrates that the order of addition does not significantly affect the dissolution yield of Li and Mn or the overall outcome of the experiment.

### EXAMPLE 6 (COMPARATIVE): USE OF H₂S AND H₂SO₄ AT 60° C. ON PYROLYZED BLACK MASS

The experimental conditions and input feed are identical as in example 1, only the added amount of sulfuric acid is different. In total 110 g H₂SO₄ solution (1000 g/L) is added to the slurry in order to reach pH 4.4 (compared to pH 2.1 in Example 1).

The slurry is filtered on a Buchner filter, resulting in a solution and solid residue. 153 g dry solid residue and 0.86 L solution is obtained. The mass balance over the complete experiment can be found in Table 6 below.

TABLE 6
Metal input and yields (in g) in solid residue and solution

| | Input | Solid residue | Solution |
|---|---|---|---|
| Ni | 30 | 30.0 | 0.0 |
| Mn | 18 | 3.4 | 14.6 |
| Co | 8.2 | 8.2 | 0.0 |
| Li | 7.7 | 0.7 | 7.0 |
| Al | 9.5 | 8.4 | 1.1 |
| Cu | 4.5 | 4.5 | 0.0 |

Working at a pH of 4.4 results in the dissolution of 80% of the Mn and 90% of the Li. This is lower than in Example 1, where Mn and Li are dissolved for 95% or more.

1-15. (canceled)

16. Process for the separation of Li from oxides of one or more of Co and Ni contained in a feed, comprising the steps of:
contacting, in an aqueous medium, the feed with a quantity of sulfidizing agent, sufficient to convert a major part of the Co and/or Ni to sulfides, and a quantity of mineral acid sufficient to reach a pH of 1 to 3, at an absolute pressure of less than 0.3 MPa, thereby forming an aqueous slurry containing solid Co and/or Ni sulfides, and a solution containing Li; and,
separating the solids from the solution, thereby obtaining solids containing Co and/or Ni sulfides, and a solution containing at least 70% of the Li.

17. The process according to claim 16, wherein the sulfidizing agent used in the step of contacting is one or more of H₂S, NaHS, and Li₂S.

18. The process according to claim 16, wherein the sulfidizing agent used in the step of contacting is generated in situ, by adding elemental sulfur under reducing conditions.

19. The process according to claim 16, wherein in the step of contacting, the quantity of mineral acid is at least partially generated in situ by addition of a solution containing dissolved Co and/or Ni.

20. The process according to claim 16, wherein the step of contacting is performed at an absolute pressure of less than 0.1 MPa.

21. The process according to claim 16, wherein the solids obtained in the step of separating comprise at least 70% of the Co and/or Ni.

22. The process according to claim 16, wherein the solution obtained in the step of separating, comprises at least 85% of the Li.

23. The process according to claim 16, wherein the feed further contains oxides of Mn, and wherein the Mn is dissolved together with the lithium, thereby obtaining a solution containing the major part of the lithium and the major part of the manganese.

24. The process according to claim 23, wherein said solution comprises at least 70% of the Mn.

25. The process according to claim 16, wherein at least the metal oxides contained in the feed are in the form of a powder.

26. The process according to claim 16, wherein the feed is derived from Li-ion batteries, battery scrap and/or their production waste.

27. The process according to claim 16, wherein the process is performed at a temperature of 80° C. or less.

28. The process according to claim 16, wherein the quantity of mineral acid is predetermined according to stoichiometric reactions, the addition being performed in at least 2 steps, the first addition step being limited to at most 80% of the predetermined amount.

29. The process according to claim 28, wherein the first addition step is terminated at a pH of above 3.3, and wherein the second or any subsequent addition step is terminated at a pH between 1.5 and 3.

30. The process according to claim 16, wherein the Co and/or Ni sulfides obtained in the step of separating the solids are used as starting material in a subsequent hydrometallurgical refining process.
